(19) United States
(12) Patent Application Publication
(10) Pub. No.: US 2012/0055246 A1
(43) Pub. Date: Mar. 8, 2012

(54) ACOUSTIC LIQUID MEASUREMENT

(75) Inventor: Jan Boström, Goteborg (SE)

(73) Assignee: Axsensor AB, Goteborg (SE)

(21) Appl. No.: 12/998,890

(22) PCT Filed: Dec. 14, 2009
(86) PCT No.: PCT/EP2009/067087

§ 371 Date: Aug. 26, 2011

Related U.S. Application Data
(60) Provisional application No. 61/193,696, filed on Dec. 17, 2008.

(51) Int. Cl. G01F 23/22

(52) U.S. Cl. 73/295

(57) ABSTRACT

A device is disclosed for providing a temperature compensated measurement of the level of a liquid in a tank. The device includes a transducer for transmitting and receiving acoustic signals, a waveguide connected to the transducer and adapted to extend into the liquid, and at least one device for directing a flow of heat transfer fluid originating from a heat transfer system along the exterior of a portion of the waveguide which during operation is located above the liquid level. Further, a device is disclosed for controlling a heat regulating device adapted to regulate a temperature of a liquid in a tank, including a transducer for transmitting and receiving acoustic signals, a waveguide connected to the transducer, the waveguide having a reference portion located above the liquid surface, and a control device configured to measure the speed of sound in the reference portion as an indication of a temperature in the liquid, and control the heat regulating device based on the indicated temperature.

### TECHNICAL FIELD

The present invention relates to a device and method for providing a temperature compensated measurement of the level of a liquid in a tank. The present invention also relates to a device and method for controlling a heat regulating device adapted to regulate a temperature of a liquid in a tank.

### TECHNICAL BACKGROUND

Liquid in a tank can be heated by arranging a heating device in the liquid. The heating device can e.g. utilize a flow of hot fluid passing through a heating coil to warm the liquid in the tank. In some applications the hot fluid may be heat transfer fluid from a heat transfer system. An example thereof would be heating of a urea-water solution in a tank in a vehicle equipped with Selective Catalytic Reduction (SCR) technology to prevent the urea-water solution from freezing.

SCR technology is increasingly used to reduce emissions of nitrogen oxides from the exhaust of diesel vehicles in order to meet future emission standards.

For a diesel vehicle, this is typically achieved by injecting a urea-water solution into the exhaust gas flow of the engine. As the urea-water solution reaches the SCR catalytic converter the urea-water solution is split into ammonia and water due to the high temperature prevailing therein. The ammonia may then convert nitrogen oxides to nitrogen and water.

As the freezing point of the urea-water solution is about −11° C., a heating device may be provided for heating the urea-water solution to prevent freezing. The heating device may comprise a heating coil arranged in the tank and extending into the urea-water solution therein. The heating coil is connected to the engine cooling system, wherein coolant which has been heated by the engine flows through the heating coil before being returned to the engine cooling system, thereby heating the urea-water solution. The heat regulating device may be provided with a temperature sensor, arranged in the liquid, measuring the temperature of the liquid to determine when heating is required, and a floater to measure the level of the urea-water solution in the tank.

### SUMMARY OF THE INVENTION

According to a first aspect of the invention, there is provided a device for providing a temperature compensated measurement of the level of a liquid in a tank, comprising a transducer for transmitting and receiving acoustic signals, a waveguide connected to the transducer and adapted to extend into the liquid, and means for directing a flow of heat transfer fluid originating from a heat transfer system along the exterior of a portion of the waveguide which during operation is located above the liquid level. By having means for directing the flow of liquid originating from the heat transfer system along the exterior of a portion of the waveguide which is located above the liquid level, the temperature becomes essentially the same throughout the whole of the waveguide, whereby the level measurement using the speed of sound in the waveguide, which speed is temperature dependant, becomes very accurate.

The heat transfer system may be a cooling system of an engine. However, other heat transfer systems may also be utilized, such as a system used for heating the air in the vehicle coupé.

In one embodiment, the directing means is an input and/or output pipe of a heat regulating device adapted to regulate a temperature of the liquid in the tank, wherein the heat regulating device utilize a heat transfer fluid originating from the heat transfer system to regulate the temperature of the liquid in the tank. The heat transfer fluid may be utilized for heating or cooling the liquid in the tank depending on the application. An advantage with using the input and/or output pipe of the heat regulating device is that no additional dedicated means are required to enable temperature compensated measurement. Preferably, the waveguide and the input and/or output pipe are arranged adjacent to each other. For example, part of the waveguide can be arranged along side the input and/or output pipe so that the temperature of the latter can be transferred to the former. In another example, part of the waveguide is accommodated in a housing and the input and/or output pipe runs adjacent to or through the housing, again for transferring the temperature from the input and/or output pipe to the waveguide. Further, the waveguide and the input and/or output pipe can be integrated to a single structure, which facilitates manufacturing and assembly and lowers cost.

Furthermore, the device for providing a temperature compensated measurement of the level of a liquid in a tank according to the present invention may advantageously be included in a tank arrangement, further comprising a tank, and a heat regulating device adapted to regulate a temperature of a liquid in the tank.

According to a second aspect of the invention, there is provided a method for providing a temperature compensated measurement of the level of a liquid in a tank, comprising transmitting an acoustic signal from a transducer into a waveguide adapted to extend into the liquid, receiving a reflected acoustic signal to the transducer from the waveguide, and directing a flow of heat transfer fluid originating from a heat transfer system along the exterior of a portion of the waveguide which during operation is located above the liquid level. This aspect exhibits similar advantages as the previously discussed aspect of the invention.

According to a third aspect of the invention, there is provided a device for controlling a heat regulating device adapted to regulate a temperature of a liquid in a tank, comprising: a transducer for transmitting and receiving acoustic signals, a waveguide connected to the transducer, the waveguide having a reference portion adapted to be located above the liquid surface when the device is arranged at the tank, and a control device configured to measure the speed of sound in the reference portion as an indication of a temperature in the liquid, and control the heat regulating device based on the indicated temperature.

The heat regulating device may be used to heat or cool the liquid in the tank. It may connected to a heat transfer system supplying a flow of heat transfer fluid or be an electric heater.

The control device may be configured to measure a transit time of an acoustic signal in the reference portion as an indication of a temperature in the liquid.

Since the length of the reference portion is constant, the transit time is inversely proportional to the velocity of the acoustic signal. Furthermore, the speed of sound typically depends on the medium in which the acoustic signal propagates and the temperature. If the evaporation of liquid in the tank is low the gas composition in the reference portion of the waveguide is essentially constant over time. This means that the transit time will be a function of temperature only and the transit time may thus serve as an indication of the temperature in the reference portion of the waveguide. Furthermore, as the temperature in the reference portion of the waveguide typically will depend on the temperature in the liquid in the tank, the transit time also indicates the temperature in the liquid.

An advantage is that no conventional temperature sensor is required to measure the temperature in the liquid, thereby enabling a cost-efficient solution as the same components (e.g. transducer and waveguide) can be utilized for the device controlling the heat regulating device and a device for acoustic liquid level measurement.

The waveguide may further comprise a reference element, whereby the part of the waveguide between the transducer and the reference element is defined as the reference portion.

The reference portion of the waveguide may be located inside the tank (but above the liquid surface). An advantage is that the temperature in the reference portion may better reflect the temperature in the liquid.

The device may comprise means for directing a flow of liquid originating from the tank along the exterior of a portion of the reference portion of the waveguide. This allows “the temperature” of the liquid to be transferred to the reference portion of the waveguide, thereby enabling the temperature indicated by the transit time to better reflect the temperature in the liquid.

The directing means may comprise a pipe, such as, for example a suction and/or return pipe for directing a flow of liquid in and out of the tank.

Preferably, the reference portion of the wave guide and the suction and/or return pipe are arranged adjacent to each other. For example, the reference portion can be arranged along side the suction and/or return pipe so that the temperature of the latter can be transferred to the former. In another example, reference portion of the waveguide is accommodated in a housing and the suction and/or return pipe runs adjacent to or through the housing, again for transferring the temperature from the suction and/or return pipe to the reference portion of the waveguide. Further, the reference portion of the waveguide and the suction and/or return pipe can be integrated to a single structure, which facilitates manufacturing and assembly and lowers cost.

Furthermore, the device for controlling a heat regulating device according to the present invention may advantageously be included in a tank arrangement, further comprising a tank, and the heat regulating device adapted to regulate a temperature of a liquid in the tank.

According to a fourth aspect of the invention, there is provided a method for controlling a heat regulating device adapted to regulate a temperature of a liquid in a tank, the method comprising the steps of: transmitting an acoustic signal from a transducer into a waveguide, receiving a reflected acoustic signal to the transducer from the waveguide, measuring the speed of sound in a reference portion of the waveguide located above the liquid surface, as an indication of a temperature in the liquid; controlling the heat regulating device based on the indicated temperature.

This aspect exhibits similar advantages as the third aspect of the invention.

The method may further comprise the step of measuring a transit time of the acoustic signal in a reference portion of the waveguide located above the liquid surface as an indication of a temperature in the liquid.

The method may comprise directing a flow of liquid originating from the tank along the exterior of a portion of the reference portion of the waveguide.

The third and fourth aspects of the invention may be combined with the first and second aspects, but may also advantageously be provided independently from said first and second aspects.

### BRIEF DESCRIPTION OF THE DRAWINGS

These and other aspects of the present invention will now be described in more detail, with reference to the appended drawings showing currently preferred embodiments of the invention.

FIG. 1 is a schematic perspective view of a tank with a measurement device according to an embodiment of the present invention.

### DETAILED DESCRIPTION OF CURRENTLY PREFERRED EMBODIMENTS

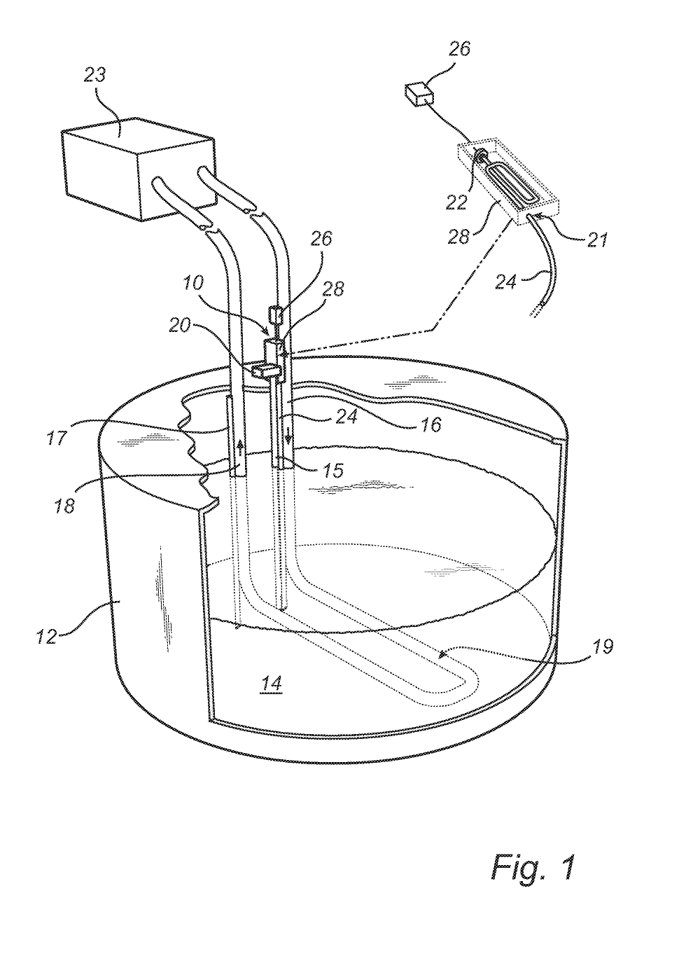

FIG. 1 is a schematic perspective view of a tank 12 with a measurement device 10 according to an embodiment of the present invention. The tank 12 is here a tank for a urea-water solution provided in a vehicle with Selective Catalytic Reduction technology, such as a car, a truck or a boat, and the measurement device 10 is adapted to detect the level of urea-water solution 14 in the tank 12.

In the tank 12 there is provided a suction pipe 15 and a return pipe 17. The suction pipe 15 is connected to a pump 20 placed outside the tank 12, while the return pipe 17 is connected to a return system (not shown) also placed outside the tank 12. The suction pipe and the return pipe may be integrated to a single structure.

Upon operation, urea-water solution 14 from the tank 12 is sucked up by the pump 20 via the suction pipe and supplied to the catalytic converter to reduce emissions of nitrogen oxides from the vehicle according to known techniques, while excessive or “unused” urea-water solution is returned to the tank 12 via the return pipe.

Thus, during operation, a flow of urea-water solution is provided in both the suction 15 and return pipe 17 by the pump 20 and the return system, respectively.

In the tank 12, there is also provided a heat regulating device 19 extending into the urea-water solution 14. Here, the heat regulating device 19 has a U-shaped portion extending in a horizontal plane near the bottom of the tank and an input pipe 16 and an output pipe 18 leading to the top of the tank. The input pipe 16 and the output pipe 18 is connected to a heat transfer system 23. In the illustrated case, the heat transfer system 23 is an engine cooling system 23 and the heat transfer fluid is coolant that has been used to cool the engine. Thus, the heat regulating device is here a heating device.

The input pipe and the output pipe may be integrated to a single structure.

Upon operation, heat transfer fluid is supplied to the heat regulating device via the input pipe 16 and is then returned to the heat transfer system 23 via the output pipe 18. Thus, during operation, a flow of heat transfer fluid is provided in both the input pipe 16 and the output pipe 18 by the heat transfer system 23. Furthermore, as the heat transfer fluid flows through the heat regulating device the urea-water solution 14 is heated.

The structure and operation of the measurement device 10 will now be described with reference to FIG. 1. The measurement device 10 comprises a transducer 22 and a waveguide 24 connected to the transducer 22. In FIG. 1, the transducer 22 is placed outside the tank 12, but it could alternatively be placed inside at the top of the tank 12. The transducer 22 is further arranged in connection with an electronic control device 26, which also is placed outside the tank 12. Further, the transducer 22 may be a combined unit, or comprise a separate transmitter and receiver.

The waveguide 24 extends from the transducer 22 down to the bottom of the tank 12, into the urea-water solution 14. More precisely, according to the present embodiment of the invention, the waveguide 24 is arranged along side of the input pipe 16 and/or the output pipe 18. The waveguide 24 and at least one of the input pipe 16 and the output pipe 18 may be placed in contact with each other (as in FIG. 1) and they may even be integrated to a single structure. Also, the waveguide 24 and at least one of the input pipe 16 and the output pipe 18 may be enclosed by a common elongated housing pipe (not shown). Further, the portion of the waveguide 24 close to the transducer 22 having a flat spiral shape, or any housing 28 accommodating said portion, is here positioned close to or in contact with the input pipe 16 and/or the output pipe 18. Alternatively, the input pipe 16 and/or the output pipe 18 could run through the housing 28 (not shown).

Upon operation of the measurement device 10, the electronic control device 26 energizes the transducer 22 to generate acoustic pulses. A pulse transmitted from the transducer 22 is guided through the waveguide 24 towards the surface of the urea-water solution 14 in the tank 12, which pulse travels through the waveguide 24, is then reflected by the surface, and finally returns to the transducer 22. In response to the returning pulse, the transducer 22 generates a corresponding signal to the control device 26. By knowing the transit time and velocity of the pulse, the control device 26 can calculate the fuel level or fuel volume in the tank 12. To increase the accuracy of the measurements, the measurement device 10 can further comprise a reference system. For instance, a reference element 21 could be provided in the waveguide, preferably just after the spiral portion and above the highest possible fuel level, creating a reference portion of the waveguide between the transducer and the reference element. An example of such a reference system and more is described in the above mentioned document WO2005038415, the content of which hereby is incorporated by reference. Further, since they are arranged adjacent to each other, the flow of heat transfer fluid in the input pipe 16 and/or the output pipe 18 is directed along the exterior of the waveguide 24. This, and the fact that the housing 28 also is arranged adjacent to the input pipe 16 and/or the output pipe 18, allows “the temperature” of the heat transfer fluid in the input pipe 16 and/or the output pipe 18 to be transferred to a portion of the waveguide 24 which is located above the level of the urea-water solution, which levels the conditions throughout the waveguide 24 with respect to temperature, which in turn allows more accurate measurements since the velocity of the acoustic pulses (which depends on temperature) becomes essentially the same throughout the waveguide 24 located above the main level of the urea-water solution.

According to another embodiment of the invention, the above described reference system may be utilized for controlling the operation of the heat regulating device based on the temperature in the liquid in the tank as follows.

An acoustic pulse is transmitted by the transducer 22.

The control device 26 measures a transit time of the acoustic pulse in a reference portion of the waveguide located above the liquid surface.

Here the reference portion is the part of the waveguide between the transducer and the reference element 21 which is here provided in the waveguide, just after the spiral portion and above the highest possible fuel level. Thus, the transit time is here the time it takes until an echo reflected by the reference element 21 is detected by the transducer.

Since the length of the reference portion is constant, the transit time depends on the velocity of the acoustic pulse, i.e. on the speed of sound in the reference portion of the waveguide.

As the liquid in the tank is here urea-water solution, with a low evaporation, the gas in the reference portion of the waveguide will typically be air. Thus, the transit time will be a function of temperature. Consequently, the transit time serves as a indication of the temperature in the reference portion of the waveguide. Since the temperature in the reference portion typically is affected by the temperature of the liquid in the tank, the transit time will also serve as an indication of the temperature of the liquid. In some applications it can be assumed that the temperature in the reference portion and the temperature in the liquid is the same. However, as is recognized by a person skilled in the art that, a function or a conversion factor can be utilized to describe the relationship between the temperature in the reference portion and the temperature in the liquid.

The control device 26 may then control the temperature of the heat regulating device based on the indicated temperature e.g. by controlling the flow of heat transfer fluid supplied to the heat regulating device. For example, instead of having a constant flow of heat transfer fluid to the heat regulating device 19, the control device 26 can “turn on” the heat regulating device when heating of the liquid is required, e.g. when the temperature in the liquid falls below a predetermined threshold temperature so that the heat transfer fluid starts flowing through the heat regulating device to prevent the liquid from freezing.

In the present embodiment, the waveguide 24 may preferably be arranged along side the suction pipe 15 and/or the return pipe 17. The waveguide 24 and at least one of the suction pipe 15 and the return pipe 17 may be placed in contact with each other (as in FIG. 1) and they may even be integrated to a single structure. Also, the waveguide 24 and at least one of the suction pipe 15 and the return pipe 17 may be enclosed by a common elongated housing pipe (not shown).

In particular, the reference portion of the waveguide, or any housing 28 accommodating the reference portion, may preferably be positioned close to or in contact with the suction pipe 15 and/or the return pipe 17. Alternatively, the suction pipe 15 and/or the return pipe 17 could run through the housing 28 (not shown).

Further, since they are arranged adjacent to each other, the flow of urea-water solution in the suction pipe 15 and/or the return pipe 17 is directed along the exterior of the waveguide 24. This, and the fact that the housing 28 also is arranged adjacent to the suction pipe 15 and/or the return pipe 17, allows “the temperature” of the urea-water solution in the suction pipe 15 and/or the return pipe 17 to be transferred to a portion of the waveguide 24 which is located above the level of the urea-water solution, wherein the temperature in the reference portion of the waveguide will better reflect the temperature in the urea-water solution, which in turn makes the measured transit time in the reference portion of the waveguide more accurately reflect the temperature in the urea-water solution.

Although the waveguide illustrated in FIG. 1 is arranged adjacent to the input pipe 16, it may also be arranged apart from the input and output pipes of the heat regulating device to avoid that “the temperature” of the heat transfer fluid in the input pipe 16 and/or the output pipe 18 is transferred to the reference portion of the waveguide 24.

The reference portion of the waveguide may also be arranged inside the tank (above the liquid level). This may be an alternative way to adapt the temperature in the reference portion to the temperature in the liquid.

The person skilled in the art realizes that the present invention by no means is limited to the preferred embodiments described above. On the contrary, many modifications and variations are possible within the scope of the appended claims. For example, although acoustic pulses have been used in the described embodiments, the inventive measurement device may also be used with other measurement modes such as standing wave measurement. For standing wave measurements, the speed of sound in the reference portion of the waveguide can be found by finding a frequency of a standing wave in the reference portion (instead of measuring the transit time as was described above). Furthermore, although the described embodiments disclose a tank containing urea-water solution, the invention may also be utilized for other liquids.

Although above described heat regulating device is utilized to heat a liquid in a tank, the heat regulating device may also be utilized for cooling a liquid. Furthermore, the heat regulating device may also be an electric heater.

1. A device for providing a temperature compensated measurement of the level of a liquid in a tank, comprising:
a transducer for transmitting and receiving acoustic signals,
a waveguide connected to the transducer and adapted to extend into the liquid, and
means for directing a flow of heat transfer fluid originating from a heat transfer system along the exterior of a portion of the waveguide which during operation is located above the liquid level.

2. A device according to claim 1, wherein said heat transfer system is a cooling system of an engine.

3. A device according to claim 2, wherein the directing means is an input and/or output pipe of a heat regulating device adapted to regulate a temperature of the liquid in said tank.

4. A device according to claim 3, wherein the waveguide and at least one of the input and output pipe are arranged adjacent to each other.

5. A device according to claim 3, wherein at least part of the waveguide and the input and/or output pipe are arranged along side each other.

6. A tank arrangement, comprising:
a tank,
a heat regulating device adapted to regulate a temperature of a liquid in the tank, and
a device according to claim 1.

7. A method for providing a temperature compensated measurement of the level of a liquid in a tank, comprising:
transmitting an acoustic signal from a transducer into a waveguide adapted to extend into the liquid,
receiving a reflected acoustic signal to the transducer from the waveguide, and directing a flow of heat transfer fluid originating from a heat transfer system along the exterior of a portion of the waveguide which during operation is located above the liquid level.

8. A device for controlling a heat regulating device adapted to regulate a temperature of a liquid in a tank, comprising:
a transducer for transmitting and receiving acoustic signals,
a waveguide connected to the transducer, said waveguide having a reference portion adapted to be located above the liquid surface when said device is arranged in said tank,
and a control device configured to measure the speed of sound in said reference portion as an indication of a temperature in the liquid, and control the heat regulating device based on the indicated temperature.

9. A device according to claim 8, wherein the control device is configured to measure a transit time of an acoustic signal in the reference portion as an indication of a temperature in the liquid.

10. A device according to claim 8, wherein said waveguide further comprises a reference element, whereby the part of the waveguide between said transducer and said reference element is defined as the reference portion.

11. A device according to claim 8, wherein said reference portion is located inside the tank.

12. A temperature measurement device according to claim 8, further comprising means for directing a flow of liquid originating from the tank along the exterior of a portion of the reference portion of the waveguide.

13. A temperature measurement device according to claim 12, wherein the directing means comprises a pipe.

14. A tank arrangement, comprising:
a tank,
a heat regulating device adapted to regulate a temperature of a liquid in said tank,
a device according to claim 8 adapted to control the heat regulating device.

15. A method for controlling a heat regulating device adapted to regulate a temperature of a liquid in a tank, said method comprising the steps of:
transmitting an acoustic signal from a transducer into a waveguide, receiving a reflected acoustic signal to the transducer from the waveguide,
measuring the speed of sound in a reference portion of the waveguide located above the liquid surface, as an indication of a temperature in the liquid;
controlling the heat regulating device based on the indicated temperature.

16. A method according to claim 15, further comprising the step of measuring a transit time of the acoustic signal in a reference portion of the waveguide located above the liquid surface, as an indication of a temperature in the liquid.

17. A method according to claim 15, further comprising directing a flow of liquid originating from the tank along the exterior of a portion of the reference portion of the waveguide.
